(19) United States
(12) Patent Application Publication
(10) Pub. No.: US 2024/0278352 A1
(43) Pub. Date: Aug. 22, 2024

(54) LASER MACHINING APPARATUS AND LASER MACHINING METHOD

(71) Applicant: Mitsubishi Electric Corporation, Tokyo (JP)

(72) Inventors: Takanori MIYAZAKI, Tokyo (JP); Takuma DAIMON, Aichi (JP)

(73) Assignee: Mitsubishi Electric Corporation, Tokyo (JP)

(21) Appl. No.: 18/570,641

(22) PCT Filed: Sep. 24, 2021
(86) PCT No.: PCT/JP2021/035060

§ 371 Date: Dec. 15, 2023

(51) Int. Cl. B23K 26/14; B23K 26/06

(52) U.S. Cl. CPC B23K 26/1476; B23K 26/0648

(57) ABSTRACT

A laser machining apparatus includes a laser oscillator, a machining head, and a controller. The laser oscillator outputs laser light. The machining head includes: a nozzle having a divergent-shape on an outlet side thereof through which the laser light is emitted to a workpiece; and a condensing lens that condenses the laser light at a focus position. The machining head ejects machining gas to the workpiece and ejects cooling gas to the nozzle through a path different from a path for the machining gas. The controller controls the focus position of the laser light such that the focus position is located inside the machining head and away from a smallest-inner-diameter portion of the nozzle in a direction toward the condensing lens. The laser light is emitted to the workpiece without a ring beam being formed. The machining gas is ejected to the workpiece coaxially with the laser light.

### FIELD

The present disclosure relates to a laser machining apparatus and a laser machining method for machining a workpiece by irradiating the workpiece with laser light.

### BACKGROUND

A laser machining apparatus machines a workpiece by irradiating the workpiece with laser light output from a laser oscillator. It is desired that the laser machining apparatus stably perform high-quality machining.

A laser machining apparatus disclosed in Patent Literature 1 forms a laser beam output from a laser oscillator, into a ring shape and irradiates a workpiece with a ring-shaped laser beam, and, at the same time, ejects an oxygen gas along a ring axis of the ring-shaped laser beam. As a result, the laser machining apparatus disclosed in Patent Literature 1 cuts a workpiece having a large plate thickness.

### CITATION LIST

### Patent Literature

Patent Literature 1: International Publication No. WO 2010/095744

### SUMMARY OF INVENTION

### Problem to be Solved by the Invention

Unfortunately, the technique disclosed in Patent Literature 1 requires an additional optical component for forming the laser beam into the ring shape. This leads to problems such as frequent occurrence of machining defects due to contamination of the optical component and deterioration in machining quality.

The present disclosure has been made in view of the circumstances, and an object of the present disclosure is to provide a laser machining apparatus capable of stably cutting, with high quality, a workpiece having a large plate thickness.

### Means to Solve the Problem

In order to solve the above-described problems and achieve the object, a laser machining apparatus according to the present disclosure comprises: a laser oscillator to output laser light having a wavelength band of 1 μm; and a machining head including: a nozzle having a divergent-shape on an outlet side thereof through which the laser light is emitted to a workpiece; and a condensing lens to condense the laser light at a focus position, the machining head being to eject machining gas to the workpiece, and eject cooling gas to the nozzle through a path different from a path for the machining gas, the machining gas being sent from a machining gas supply source to supply the machining gas, the cooling gas being sent from a cooling gas supply source to supply the cooling gas. The laser machining apparatus of the present disclosure further comprises a controller to control the focus position of the laser light. The controller controls the focus position of the laser light such that the focus position is located inside the machining head and away from a smallest-inner-diameter portion of the nozzle in a direction toward the condensing lens, the laser light is emitted to the workpiece without a ring beam being formed, and the machining gas is ejected to the workpiece coaxially with the laser light.

### Effects of the Invention

The laser machining apparatus according to the present disclosure has an effect of stably cutting, with high quality, a workpiece having a large plate thickness.

### BRIEF DESCRIPTION OF DRAWINGS

FIG. 1 is a diagram illustrating a configuration of a laser machining apparatus according to an embodiment.

FIG. 2 is a diagram illustrating a configuration of a machining head of the laser machining apparatus according to the embodiment.

FIG. 3 is an explanatory diagram illustrating a focus position in laser light irradiation performed by the laser machining apparatus according to the embodiment.

FIG. 4 is a perspective view illustrating a configuration of an insulation part of the laser machining apparatus according to the embodiment.

FIG. 5 is an explanatory diagram illustrating an upper surface configuration and a sectional configuration of the insulation part illustrated in FIG. 4.

FIG. 6 is a diagram illustrating a configuration of a controller of the laser machining apparatus according to the embodiment.

FIG. 7 is a flowchart illustrating a machining procedure of laser machining performed by the laser machining apparatus according to the embodiment.

FIG. 8 is a diagram illustrating a first different configuration of the machining head of the laser machining apparatus according to the embodiment.

FIG. 9 is a diagram illustrating a second different configuration of the machining head of the laser machining apparatus according to the embodiment.

FIG. 10 is an explanatory diagram illustrating a comparison result between machining performed by the laser machining apparatus according to the embodiment and machining performed using a ring beam.

FIG. 11 is a diagram illustrating an example of a hardware configuration for implementing the controller according to the embodiment.

### DESCRIPTION OF EMBODIMENT

A laser machining apparatus and a laser machining method according to an embodiment of the present disclosure will be hereinafter described in detail with reference to the drawings.

### Embodiment

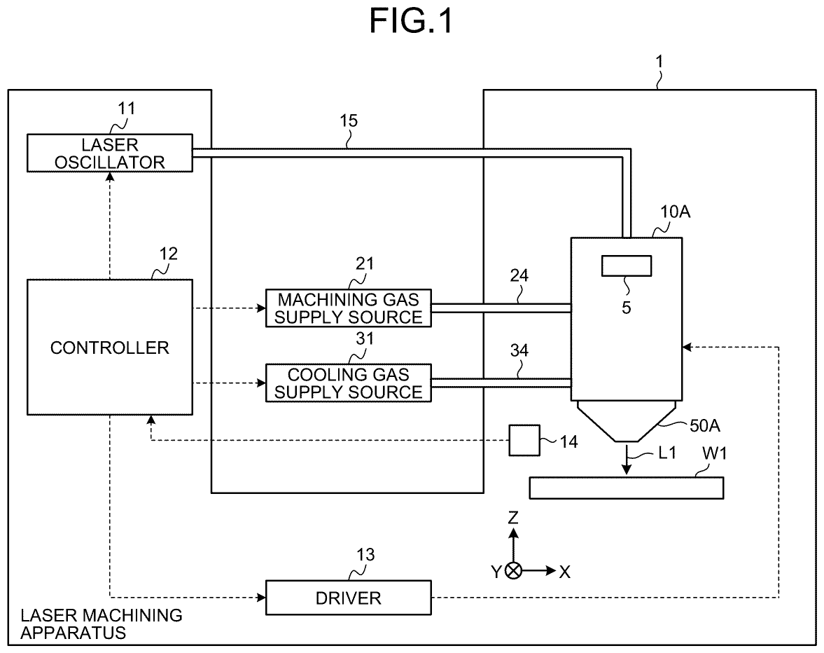

FIG. 1 is a diagram illustrating a configuration of the laser machining apparatus according to the embodiment. In the embodiment, two axes orthogonal to each other in a plane parallel to an upper surface of a target workpiece W1 are defined as an X axis and a Y axis. Additionally, an axis orthogonal to the X axis and the Y axis is defined as a Z axis. That is, an XY plane is a horizontal plane, and a Z-axis direction is a vertical direction.

A laser machining apparatus 1 is an apparatus that performs laser machining on the target workpiece W1 that is a workpiece by irradiating the target workpiece W1 with laser light L1 that is a laser beam. The laser machining apparatus 1 includes a machining head 10A, a laser oscillator 11, a controller 12, a driver 13, and a nozzle position detector 14. The laser machining apparatus 1 is connected to a machining gas supply source 21 and a cooling gas supply source 31. These supply sources 21, 31 are disposed outside the laser machining apparatus 1.

The laser oscillator 11 outputs the laser light L1. The laser oscillator 11 is connected to the machining head 10A via an optical path 15. The laser light L1 output from the laser oscillator 11 is sent to the machining head 10A through the optical path 15.

The driver 13 drives the machining head 10A. The driver 13 moves the machining head 10A in a horizontal direction by moving the head 10A in an X-axis direction and a Y-axis direction. Additionally, the driver 13 moves the machining head 10A in the Z-axis direction, i.e., the vertical direction.

The machining head 10A includes a nozzle 50A. The nozzle position detector 14 detects a position of the nozzle 50A in a height direction (Z-axis direction). The position may be hereinafter referred to as a nozzle height. Specifically, the nozzle position detector 14 detects capacitance between the nozzle 50A and the target workpiece W1 and calculates the nozzle height based on a result of detection of the capacitance. The nozzle position detector 14 sends, to the controller 12, the nozzle height detected. The nozzle height is a height of the lowermost end of the nozzle 50A from the upper surface of the target workpiece W1. That is, the nozzle height is the shortest distance between the target workpiece W1 and the nozzle 50A.

The machining gas supply source 21 sends out machining gas. The machining gas supply source 21 is connected to the machining head 10A via a gas pipe 24. The machining gas sent out by the machining gas supply source 21 is sent to the machining head 10A through the gas pipe 24. The machining gas is assist gas that assists laser machining. An example of the machining gas includes high-purity oxygen gas.

The cooling gas supply source 31 sends out cooling gas. The cooling gas supply source 31 is connected to the machining head 10A via a gas pipe 34. The cooling gas sent out by the cooling gas supply source 31 is sent to the machining head 10A through the gas pipe 34. The cooling gas is gas for preventing an increase in temperature of the nozzle 50A of the machining head 10A.

The laser light L1, the machining gas, and the cooling gas are sent into the machining head 10A. The machining head 10A irradiates the target workpiece W1 with the laser light L1 through the nozzle 50A. Additionally, the machining head 10A ejects the machining gas to the target workpiece W1 through the nozzle 50A. The machining head 10A emits the laser light L1 and ejects the machining gas toward a position at which the target workpiece W1 is subjected to laser machining.

The machining head 10A includes an optical system component (optical component) such as a condensing lens 5 disposed above the nozzle 50A (away from the nozzle 50A in a positive Z direction). Adjustment of the optical component enables adjustment of the focus position etc. of the laser light L1. For example, the machining head 10A adjusts a position of the condensing lens 5, thus adjusting the focus position etc. of the laser light L1.

Additionally, the machining head 10A ejects cooling gas to the nozzle 50A.

The controller 12 is a computer that controls the laser oscillator 11, the driver 13, the machining gas supply source 21, and the cooling gas supply source 31. The nozzle 50A includes a portion having the smallest inner diameter. The controller 12 stores a distance from the lowermost end of the nozzle 50A to that smallest-inner-diameter portion of the nozzle 50A. On the basis of the distance stored in the controller 12 and the nozzle height, the controller 12 controls the focus position of the laser light L1 such that the focus position is located above the smallest-inner-diameter portion of the nozzle 50A, that is, such that the focus position is located away from the smallest-inner-diameter portion of the nozzle 50A in a direction toward the condensing lens 5. That is, the controller 12 controls the focus position such that the focus position is on a positive side. The positive side as used herein means a side above the upper surface of the target workpiece W1, that is, in the positive Z direction from the upper surface of the target workpiece W1. As described above, the controller 12 controls the focus position such that the focus position is on a defocus side.

The controller 12 according to the present embodiment controls the driver 13 such that the focus position is located inside the machining head 10A. For example, the controller 12 sets the focus position to a position corresponding to a height of +15 mm or more from the upper surface of the target workpiece W1.

Additionally, the controller 12 controls the laser light L1 such that the laser light L1 at the focus position has φ 300 μm (the diameter of 300 μm) or less. That is, the controller 12 controls the laser light L1 such that the thinnest part of the laser light L1 has q 300 μm or less. The thinnest part of the laser light L1 is the focus position.

The laser machining apparatus 1 cuts the target workpiece W1 by moving the machining head 10A horizontally, irradiating the plate-shaped target workpiece W1 with the laser light L1. The laser machining apparatus 1 irradiates the target workpiece W1 with the laser light L1 having a wavelength band of, for example, 1 μm. Additionally, the target workpiece W1 to be subjected to laser machining by the laser machining apparatus 1 may be, for example, a mild steel plate having a plate thickness of 16 mm or more, or a mild steel plate having a plate thickness of 25 mm or more.

The material composition of these mild steel plates may be any composition. The mild steel plate may be, for example, a blast furnace material or an electric furnace material. Additionally, the mild steel plate may be of any steel type. The mild steel plate may be of, for example, SS (SS is the abbreviation of Structural Steel, rolled steel for general structure) 400 or SN (SN is the abbreviation of Steel New, rolled steel for building structure) 490A. Additionally, the mild steel plate may have any surface state. The mild steel plate may have, for example, a mill-scale surface or a shot-blasted surface. Additionally, the mild steel plate can have or need not have rust thereon.

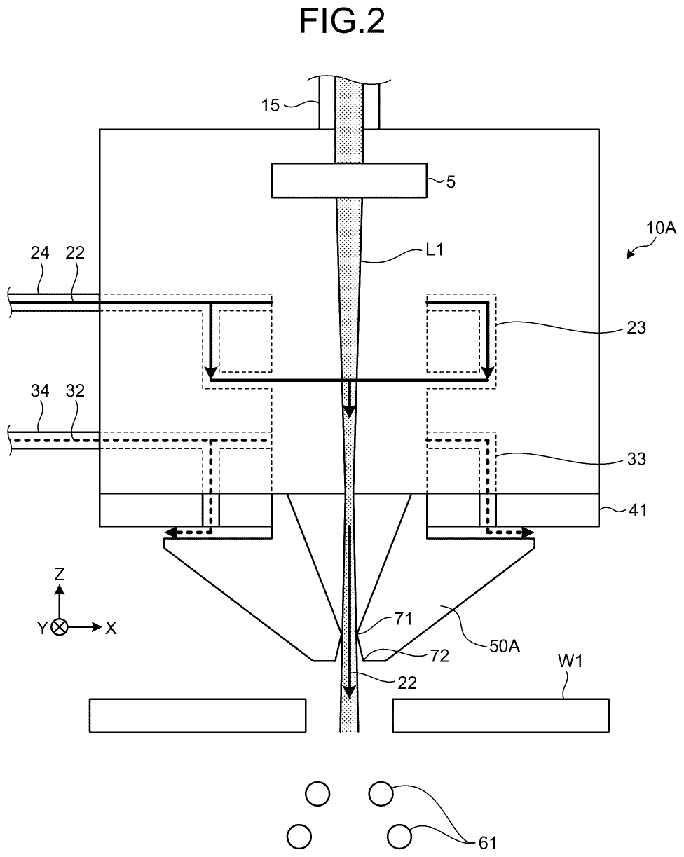

FIG. 2 is a diagram illustrating a configuration of the machining head of the laser machining apparatus according to the embodiment. FIG. 2 illustrates a sectional shape of the machining head 10A. The machining head 10A includes a generally cylindrical member. The machining head 10A includes, at its lower end, the nozzle 50A having a generally inverted conical shape. The machining head 10A has a central axis coaxial with a central axis of the nozzle 50A.

The nozzle 50A is attachable to and detachable from the machining head 10A. A nozzle other than the nozzle 50A is also attachable to the machining head 10A. The nozzle 50A has its distal end portion on an outlet side thereof through which the laser light L1 is emitted. The machining head 10A is a machining head that allows the attachment of the nozzle 50A having the distal end portion of φ 2.0 mm (inner diameter of 2.0 mm) or less.

The nozzle 50A is of a single nozzle type. The nozzle 50A has a divergent-shape defined by the outlet side through which the laser light L1 is emitted. The divergent-shape has inner and outer diameters that increase toward a lower side thereof.

The nozzle 50A is made of a cylindrical member. The nozzle 50A has inner and outer diameters that decrease toward the lower side thereof and, includes a divergent-shaped section having larger inner and outer diameters increasing toward a lower side thereof. That is, the divergent-shaped section of the nozzle 50A defines an opening that widening downstream of the laser light L1.

The divergent-shape has a top portion 71 defines the smallest-inner-diameter portion of the nozzle 50A. The divergent-shape has a bottom portion 72 defining an emission orifice for the laser light L1. The controller 12 according to the present embodiment controls the focus position such that the focus position is located above the top portion 71 of the divergent-shape (i.e., the focus portion is located away from the topmost portion 71 in the direction toward the condensing lens 5. In other words, the controller 12 controls the focus position such that the focus position is located above the smallest-inner-diameter of the nozzle 50A. The divergent-shape of the nozzle 50A is only required to have an inner diameter to such an extent that the divergent-shape is not irradiated with a central region (main beam) of the laser light L1. Thus, the divergent-shaped section of the nozzle 50A can be irradiated with a peripheral region of the laser light L1.

Additionally, the machining head 10A includes an insulation part 41 disposed on an upper portion of the nozzle 50A. The insulation part 41 is disposed between the nozzle 50A and an upper side of the machining head 10A.

The insulation part 41 is used to adjust the height of the nozzle 50A. The insulation part 41 is used to insulate the nozzle 50A from the machining head 10A. Thus, the insulation part 41 is made of an insulator.

The laser machining apparatus 1 detects capacitance between the nozzle 50A and the target workpiece W1 and controls the height of the nozzle 50A (copying control) on the basis of a result of detection of the capacitance. In order to accurately detect the capacitance, the insulation part 41 of the laser machining apparatus 1 insulates the nozzle 50A and the machining head 10A from each other.

The machining head 10A includes a machining gas path 23 that allows machining gas 22 to pass therethrough, and a cooling gas path 33 that allows cooling gas 32 to pass. The machining gas path 23 and the cooling gas path 33 are paths extending through the inside of the machining head 10A. The machining gas path 23 and the cooling gas path 33 are defined by a combination of cylindrical wall surfaces provided inside the machining head 10A.

The machining gas path 23 is defined by a single path, a plurality of paths into which the single path is divided, and a single path into which the plurality of paths converge. The plurality of paths of the machining gas path 23 each have an axis in a direction parallel to an axial direction of the laser light L1. Additionally, the path of the machining gas path 23, into which the plurality of paths converge, extends coaxially with the laser light L1.

The machining gas path 23 is connected to the gas pipe 24 at an upper stage of the machining head 10A. The machining gas path 23 extends from the upper stage of the machining head 10A to the insulation part 41 and reaches the upper portion of the nozzle 50A through the insulation part 41. The machining gas 22 having passed through the machining gas path 23 enters the nozzle 50A from a top side of the nozzle 50A and exits from a bottom side of the nozzle 50A.

The cooling gas path 33 is defined by a single path and a plurality of paths into which the single path is divided. The plurality of paths of the cooling gas path 33 each have an axis in a direction parallel to the axial direction of the laser light L1. The cooling gas path 33 is connected to the gas pipe 34 at an intermediate stage of the machining head 10A. The cooling gas path 33 extends from the intermediate stage of the machining head 10A to the insulation part 41 and reaches the upper portion of the nozzle 50A through the insulation part 41. The cooling gas 32 having passed through the cooling gas path 33 is ejected to the upper portion of the nozzle 50A and horizontally flows out of the nozzle 50A.

The machining gas path 23 and the cooling gas path 33 do not intersect with each other. That is, in the machining head 10A, the flow path for the machining gas 22 and the flow path for the cooling gas 32 are separated from each other, and the cooling gas 32 is ejected to the upper portion of the nozzle 50A through the path different from the path for the machining gas 22. Thus, the machining gas 22 and the cooling gas 32 do not mix. Note that the machining gas path 23 and the cooling gas path 33 are not limited to the above-described paths, but can be disposed in any location and form.

The laser light L1 passes through the machining head 10A from the top to the bottom along the central axis of the machining head 10A. As described above, the machining head 10A has the central axis coaxial with the central axis of the nozzle 50A. Thus, the laser light L1 is emitted to the target workpiece W1 along the central axis of the nozzle 50A. Additionally, the machining gas 22 flows in the nozzle 50A along the path extending coaxially with the laser light L1. Thus, the machining gas 22 is ejected to the target workpiece W1 along the central axis of the nozzle 50A. As a result, the laser light L1 and the machining gas 22 ejected through the nozzle 50A are ejected to the same position on the target workpiece W1.

The laser machining apparatus 1 performs laser machining by emitting the laser light L1 while delivering the machining gas 22 and the cooling gas 32. Sparks 61 are scattered during the laser machining on the target workpiece W1.

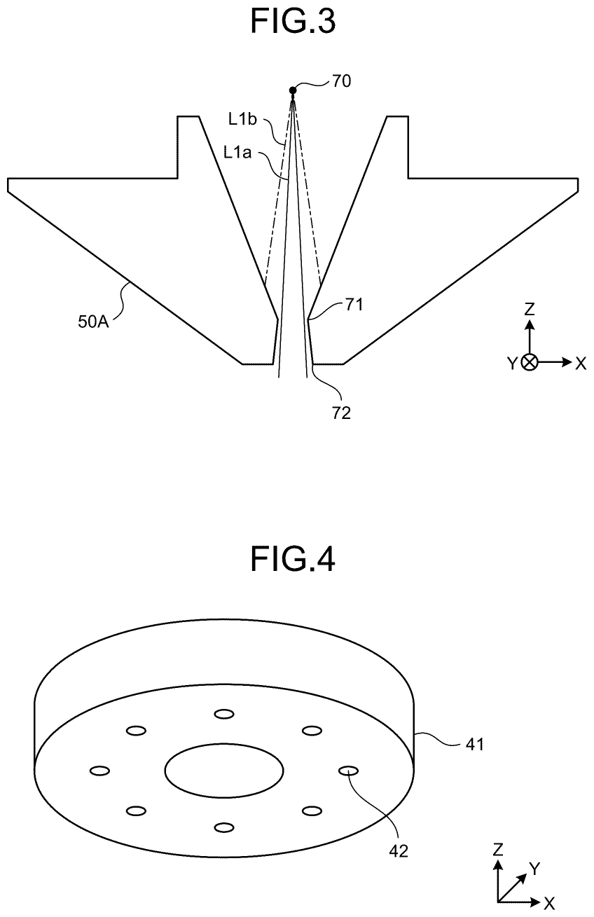

FIG. 3 is an explanatory diagram illustrating the focus position in the laser light irradiation performed by the laser machining apparatus according to the embodiment. FIG. 3 illustrates a sectional shape of the nozzle 50A. In accordance with an instruction from a user, the laser machining apparatus 1 sets a focus position 70 inside the machining head 10A including the nozzle 50A.

For example, the focus position 70 set by the laser machining apparatus 1 is at a height of +15 mm or more from the upper surface of the target workpiece W1. The laser machining apparatus 1 controls the position of the machining head 10A and the focus position 70 such that the height of +15 mm or more from the upper surface of the target workpiece W1 is within the machining head 10A. Additionally, the laser machining apparatus 1 controls the focus position of the laser light L1, that is, the thinnest part of the laser light L1 such that the focus position (i.e., the thinnest part) is φ 300 μm or less. As a result, with the beam diverging from the thinnest part of the laser light L1, the laser light L1 is emitted to a material surface, i.e., the upper surface of the target workpiece W1.

Note that, the focus position of the laser light L1 can be the narrowest part of a beam L1a or the narrowest part of a beam L1b. That is, the laser machining apparatus 1 can control the narrowest part of the beam L1a such that the narrowest part of the beam L1a has φ 300 μm or less, or control the narrowest part of the beam L1b such that the narrowest part of the beam L1b has φ 300 μm or less.

Since the laser machining apparatus 1 sets the focus position 70 inside the machining head 10A, the laser light L1 spreads below the focus position 70. Although the laser light L1 spreads in this manner, the nozzle 50A is not irradiated with the beam L1a that is the central region (main region) of the laser light L1 because the lowermost portion of the nozzle 50A is in the divergent-shape. However, the nozzle 50A is irradiated with the beam L1b that is the peripheral region of the laser light L1. Thus, in the present embodiment, the nozzle 50A is cooled by the cooling gas 32. The peripheral region of the laser light L1 is a cylindrical region surrounding the central region of the laser light L1. That is, the beam L1a is surrounded by the beam L1b. The beam L1a, which is the central region of the laser light L1, is directed out of the nozzle 50A to the target workpiece W1.

In a first example of the divergent-shape at a lower end of the nozzle 50A, the top portion 71 has φ 1.5 mm, and the bottom portion 72, which is the emission orifice for the laser light L1, has φ 1.7 mm. In a second example of the divergent-shape, the top portion 71 has q 1.7 mm, and the bottom portion 72, which is the emission orifice for the laser light L1, has φ 1.9 mm.

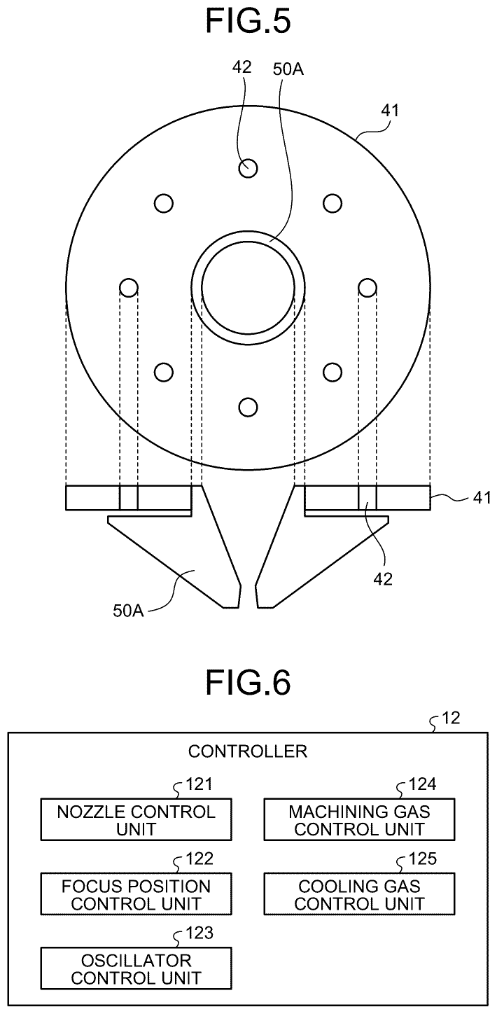

The configuration of the insulation part 41 will now be described. FIG. 4 is a perspective view illustrating the configuration of the insulation part of the laser machining apparatus according to the embodiment. FIG. 5 is an explanatory diagram illustrating an upper surface configuration and a sectional configuration of the insulation part illustrated in FIG. 4.

The insulation part 41 is in a cylindrical shape. That is, the insulation part 41 is a cylindrical member having a hollow central region extending in the axial direction thereof. The insulation part 41 is in an annular shape when viewed from above, that is, when viewed from the positive Z direction to a negative Z direction. In other words, the upper surface of the insulation part 41 is in an annular shape.

The insulation part 41 includes a plurality of gas paths 42 for allowing the cooling gas 32 to pass therethrough. Each of the gas paths 42 is a cylindrical region. In other words, the gas path 42 is defined by a cylindrical wall surface.

An axial direction of the gas path 42 is the same direction as the axial direction of the insulation part 41. That is, the axial direction of the gas path 42 is the Z-axis direction. The gas path 42 is formed through the cylindrical member of the insulation part 41 in the Z-axis direction.

FIGS. 4 and 5 each illustrate the insulation part 41 having eight gas paths 42 formed therethrough. When the insulation part 41 is viewed from above, the gas paths 42 are disposed concentrically. That is, the gas paths 42 are disposed equidistant from the central axis of the insulation part 41. Note that, the gas paths 42 is not limited in number to eight. The gas paths 42 can be, for example, two to seven, or eight or more in number.

FIG. 6 is a diagram illustrating a configuration of the controller of the laser machining apparatus according to the embodiment. The controller 12 includes a nozzle control unit 121, a focus position control unit 122, an oscillator control unit 123, a machining gas control unit 124, and a cooling gas control unit 125.

The nozzle control unit 121 determines whether the nozzle attached to the machining head 10A is the nozzle 50A having the divergent-shape. The laser machining apparatus 1 can include a nozzle changer which is not illustrated. In this case, the nozzle control unit 121 controls the nozzle changer. The nozzle control unit 121 selects a nozzle set by the user and attaches the selected nozzle to the machining head 10A.

The focus position control unit 122 controls the driver 13 to thereby control the focus position 70 of the laser light L1. Specifically, the focus position control unit 122 controls the focus position 70 of the laser light L1 by causing the driver 13 to drive the optical component of the machining head 10A. On the basis of the distance from the upper surface of the target workpiece W1 to the nozzle 50A, the focus position control unit 122 controls the focus position 70 such that the focus position 70 is located above the smallest-inner-diameter portion of the nozzle 50A.

The oscillator control unit 123 controls the laser oscillator 11 to thereby cause the laser oscillator 11 to output the laser light L1. The machining gas control unit 124 controls the machining gas supply source 21 to thereby cause the machining gas supply source 21 to send out the machining gas 22. The cooling gas control unit 125 controls the cooling gas supply source 31 to thereby cause the cooling gas supply source 31 to send out the cooling gas 32.

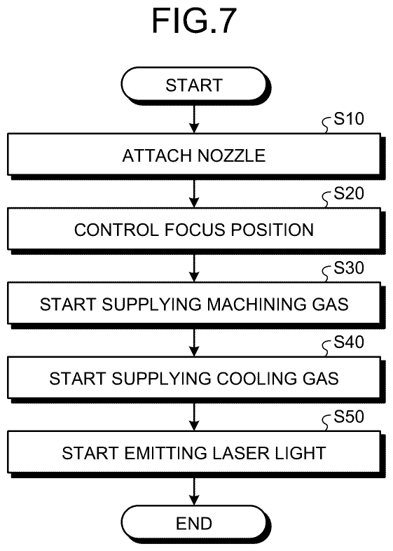

FIG. 7 is a flowchart illustrating a machining procedure of laser machining performed by the laser machining apparatus according to the embodiment. In the laser machining apparatus 1, a nozzle set by a user is attached to the machining head 10A (step S10). A nozzle can be attached to the nozzle 50A by the user or the nozzle changer. The nozzle control unit 121 determines whether the nozzle attached to the machining head 10A is the nozzle set by the user. In the laser machining apparatus 1 according to the embodiment, the nozzle control unit 121 determines whether the nozzle attached to the machining head 10A is the nozzle 50A having the divergent-shape.

In the laser machining apparatus 1, when the nozzle attached to the machining head 10A is not the nozzle set by the user, the nozzle set by the user is attached to the machining head 10A. As a result, in the embodiment, the nozzle 50A having the divergent-shape section is attached to the machining head 10A.

The focus position control unit 122 controls the driver 13 to thereby control the focus position 70 of the laser light L1 (step S20). Specifically, the focus position control unit 122 controls the driver 13 such that the focus position 70 is located above the smallest-inner-diameter portion of the nozzle 50A.

The machining gas control unit 124 controls the machining gas supply source 21 to thereby cause the machining gas supply source 21 to send out the machining gas 22. As a result, the laser machining apparatus 1 starts supplying the machining gas 22 to the machining head 10A (step S30).

The cooling gas control unit 125 controls the cooling gas supply source 31 to thereby cause the cooling gas supply source 31 to send out the cooling gas 32. As a result, the laser machining apparatus 1 starts supplying the cooling gas 32 to the machining head 10A (step S40).

Thereafter, the oscillator control unit 123 controls the laser oscillator 11 to thereby cause the laser oscillator 11 to output the laser light L1. As a result, the laser machining apparatus 1 starts emitting the laser light L1 (step S50). Note that, steps S20 to S40 can be performed in any order.

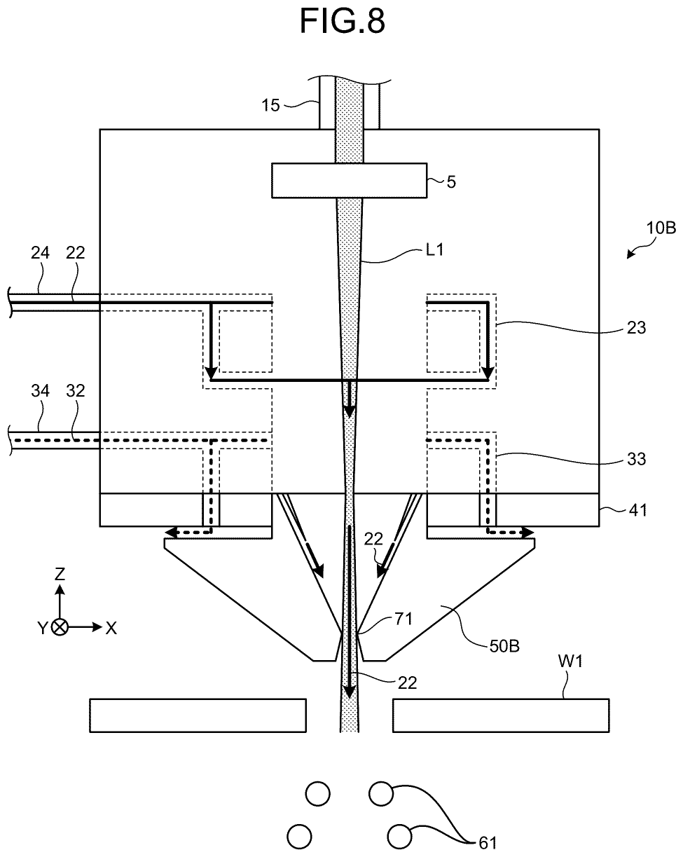

FIG. 8 is a diagram illustrating a first different configuration of the machining head of the laser machining apparatus according to the embodiment. Among components in FIG. 8, the components that achieve the same functions as those of the machining head 10A illustrated in FIG. 2 are denoted by the same reference numerals and signs, and redundant description thereof will be omitted.

Unlike the machining head 10A illustrated in FIG. 2, a machining head 10B illustrated in FIG. 8 includes a nozzle 50B instead of the nozzle 50A. The machining head 10B includes, on its lower side, the nozzle 50B having a substantially inverted conical shape. The nozzle 50B has its distal end portion on an outlet side thereof through which the laser light L1 is emitted. The machining head 10B is a machining head that allows the attachment of the nozzle 50B having the distal end portion of φ 2.0 mm (inner diameter of 2.0 mm) or less.

The nozzle 50B is of a double nozzle type. The nozzle 50B has a divergent-shape defined by the outlet side through which the laser light L1 is emitted. Like the nozzle 50A, the nozzle 50B is made of a cylindrical member. Additionally, the nozzle 50B has the divergent-shape and dimensions similar to those of the nozzle 50A.

The divergent-shape has the top portion 71 defining the smallest-inner-diameter portion of the nozzle 50B. The controller 12 controls the focus position 70 such that the focus position 70 is located above the top portion 71 of the divergent-shape, that is, above the smallest-inner-diameter portion of the nozzle 50B.

The cooling gas path 33 in the machining head 10B is the same as the cooling gas path 33 in the machining head 10A. Additionally, the machining gas path 23 in the machining head 10B is the same as the machining gas path 23 in the machining head 10A. Additionally, the optical path 15 for the laser light L1 in the machining head 10B is the same as the optical path 15 for the laser light L1 in the machining head 10A.

The nozzle 50B has a through-hole extending linearly along the central axis thereof and a through hole surrounding that linearly extending through-hole and extending in an inverted conical shape. The linearly extending through-hole formed through the nozzle 50B is similar to an axially extending through-hole formed through the nozzle 50A. The through-hole formed in the nozzle 50B and extending in the inverted conical shape extends cylindrically along a generatrix of the inverted conical shape.

With this configuration, the machining gas 22 flows through a path disposed along the central axis of the nozzle 50B, and a path disposed outside the central axis and along the inverted conical shape. Note that, since a similar effect can be obtained by using either the nozzle 50A or the nozzle 50B, description will be given below taking an example where the nozzle 50A is attached to the machining head 10A.

In the present embodiment, the controller 12 controls the driver 13 such that the focus position 70 of the laser light L1 is located inside the nozzle 50A. Specifically, the controller 12 sets the focus position 70 of the laser light L1 to a position above the smallest-inner-diameter portion of the nozzle 50A having the divergent-shape. For example, the laser machining apparatus 1 sets the focus position 70 to a position at a height of +15 mm or more from the upper surface of the target workpiece W1.

in irradiating the target workpiece W1, i.e., a material to be machined, with the laser light L1 having the wavelength band of 1 μm, the laser machining apparatus 1 shifts the focus position 70 of the laser light L1 upward to thereby increase a beam width of the laser light L1. That is, the laser machining apparatus 1 irradiates the target workpiece W1 with the laser light L1 having an increased beam width without forming a ring beam.

Additionally, the laser machining apparatus 1 promotes laser machining by ejecting, to the target workpiece W1, a flow of the machining gas 22 such as oxygen gas coaxial with the laser light L1. That is, the laser machining apparatus 1 advances the laser machining by emission of the concentrated laser light L1 and ejection of the machining gas 22 through the nozzle 50A. Furthermore, the laser machining apparatus 1 cools the nozzle 50A by ejecting, to the nozzle 50A, the cooling gas 32 through a flow path different from the flow path for the machining gas 22.

Conventionally, the focus position 70 is not set at a height of +15 mm or more from the upper surface of the workpiece because setting the focus position 70 too far from the workpiece makes it not possible to cut the workpiece. Conventionally, the focus position 70 is set on the upper surface of the workpiece, for example. In the present embodiment, the laser machining apparatus 1 sets the focus position 70 in a region having a height of +15 mm or more from the upper surface of the target workpiece W1, in which region the focus position is not set conventionally.

Description will now be given of a laser machining apparatus according to a comparative example performing laser machining on a laser machining plate that is a plate dedicated to laser machining. When the laser machining apparatus according to the comparative example irradiates the laser machining plate with laser light having a high energy density, the laser machining plate is heated at once to a temperature at which the laser machining plate melts and evaporates. To address such a situation, the laser machining apparatus according to the comparative example uses, for example, a ring beam to make a focal point thicker in the case of machining the laser machining plate dedicated to laser machining, than in the case of thin plate machining. Furthermore, the laser machining apparatus according to the comparative example burns the laser machining plate by blowing high-purity oxygen gas to the focal point, and further promotes the machining, generating oxidation reaction heat.

In some case, a laser machining plate whose surface state is not uniform due to rust etc., or a material, such as special steel, containing a component different from that of the general-purpose SS400 is machined. When the laser machining apparatus according to the comparative example performs machining in this case, a cut surface becomes rough due to being irradiated with laser light having a high energy density, and the machining becomes unstable due to excessive combustion.

Furthermore, the laser machining apparatus according to the comparative example needs to include a special optical system for forming a ring-shaped laser beam from the laser beam output from the laser oscillator. This results in an increase in cost for manufacturing the laser machining apparatus according to the comparative example. Additionally, the laser machining apparatus according to the comparative example, which includes the large number of optical components used in the optical system, is likely to cause machining defects due to the contamination of these optical components. Additionally, since the laser machining apparatus according to the comparative example includes the large number of optical components, a thermal lens phenomenon caused by a thermal load is likely to provide the unstable machining.

In contrast, the laser machining apparatus 1 according to the present embodiment increases the beam width by defocusing the laser light L1 without using the ring beam, thereby achieving an increased groove width. Furthermore, the laser machining apparatus 1 according to the present embodiment defocuses the laser light L1 to intentionally reduce its energy density at a machining point and preheat the machining point, and blows the machining gas 22 (oxygen gas or the like) of high purity to the machining point to advance the machining.

Although some laser machining apparatus performs machining mainly using a high energy density of laser light, the laser machining apparatus 1 according to the present embodiment mainly uses a combustion reaction by emission of the laser light L1 and ejection of the machining gas 22. Thus, the laser machining apparatus 1 makes no rough cut surface, avoiding experiencing a phenomenon in which machining becomes unstable. That is, the laser machining apparatus 1 can perform stable machining without being affected by the material composition, the steel type, the surface state, etc. of the mild steel plate. As described above, the laser machining apparatus 1 can stably improve machining quality without forming a ring beam even for a mild steel plate having a plate thickness of 25 mm or more.

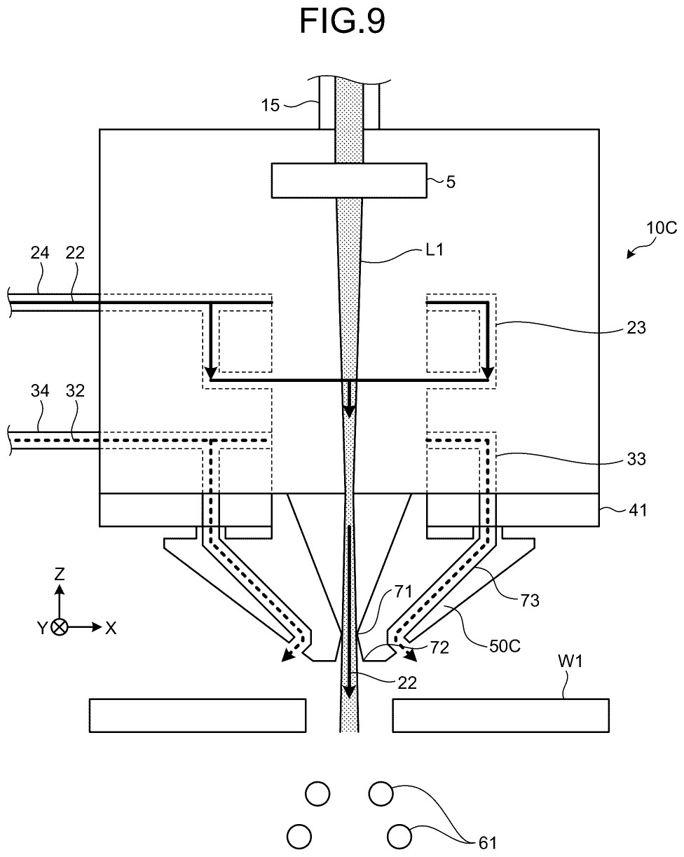

FIG. 9 is a diagram illustrating a second different configuration of the machining head of the laser machining apparatus according to the embodiment. Among components in FIG. 9, the components that achieve the same functions as those of the machining head 10A illustrated in FIG. 2 are denoted by the same reference numerals and signs, and redundant description thereof will be omitted.

Unlike the machining head 10A illustrated in FIG. 2, a machining head 10C illustrated in FIG. 9 includes a nozzle 50C instead of the nozzle 50A. The machining head 10C includes, on its lower side, the nozzle 50C having a substantially inverted conical shape. The configuration of the machining head 10C on the outlet side through which the laser light L1 is emitted is the same as the configuration of the machining head 10A on the outlet side through which the laser light L1 is emitted.

The nozzle 50C includes a cooling gas path 73 that allows the cooling gas 32 to pass therethrough. The cooling gas path 73 is a path extending through the inside of the nozzle 50C. That is, the nozzle 50C has a flow path structure that allows the cooling gas 32 to pass through the inside thereof. The cooling gas path 73 is defined by a combination of cylindrical wall surfaces provided inside the machining head 10C.

The cooling gas path 73 is connected to the cooling gas path 33 at the upper portion of the machining head 10C. The cooling gas path 73 extends from the upper portion of the machining head 10C to the vicinity of an outlet for the laser light L1. The cooling gas 32 having passed through the cooling gas path 33 enters the cooling gas path 73 from the upper portion of the nozzle 50C. The cooling gas 32 is ejected through the cooling gas path 73 from the vicinity of the outlet for the laser light L1 and flows out to the outside of the nozzle 50C.

The cooling gas path 73 and the machining gas path 23 do not intersect with each other. That is, in the machining head 10C, the flow path for the machining gas 22 and the flow path for the cooling gas 32 are separated from each other, and the cooling gas 32 is ejected from the nozzle 50C through a path different from the path for the machining gas 22. Thus, the machining gas 22 and the cooling gas 32 do not mix.

The cooling gas path 73 is not limited to the above-described path, but can be disposed in any location and form. Additionally, the cooling gas path 73 may be applied to the nozzle 50B. That is, the cooling gas path 73 may be applied to the nozzle 50A of the single nozzle type or the nozzle 50B of the double nozzle type.

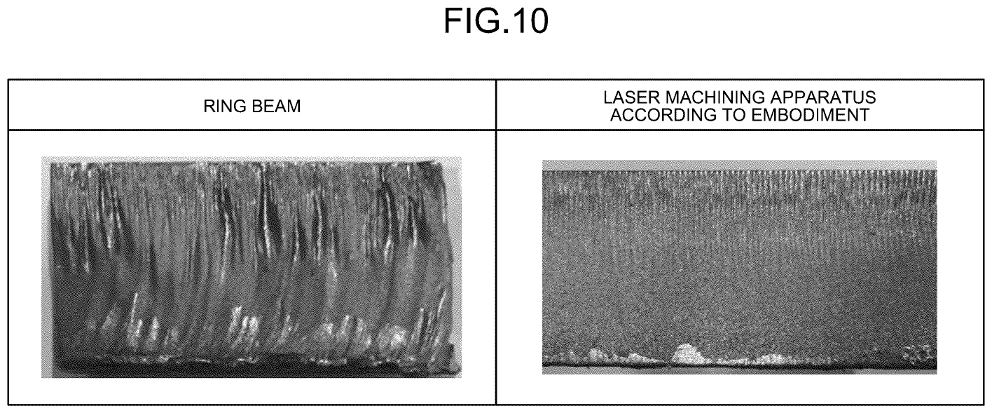

FIG. 10 is an explanatory diagram illustrating a comparison result between the machining performed by the laser machining apparatus according to the embodiment and the machining performed using the ring beam. The left side of FIG. 10 illustrates a part of the target workpiece W1 cut using the ring beam, and the right side of FIG. 10 illustrates a part of the target workpiece W1 cut by the laser machining apparatus 1 according to the embodiment.

The target workpiece W1 illustrated in FIG. 10 is mild steel SN490 At 25 mm. That is, the target workpiece W1 is Type A of the mild steel SN490 having a thickness of 25 mm. As illustrated in FIG. 10, the cutting performed using the ring beam provides the rough cut surface, and in some cases the cutting cannot be performed depending on the material or shape of the target workpiece W1. In contrast, the laser machining apparatus 1 according to the embodiment can achieve the stable cutting irrespective of the material and the shape.

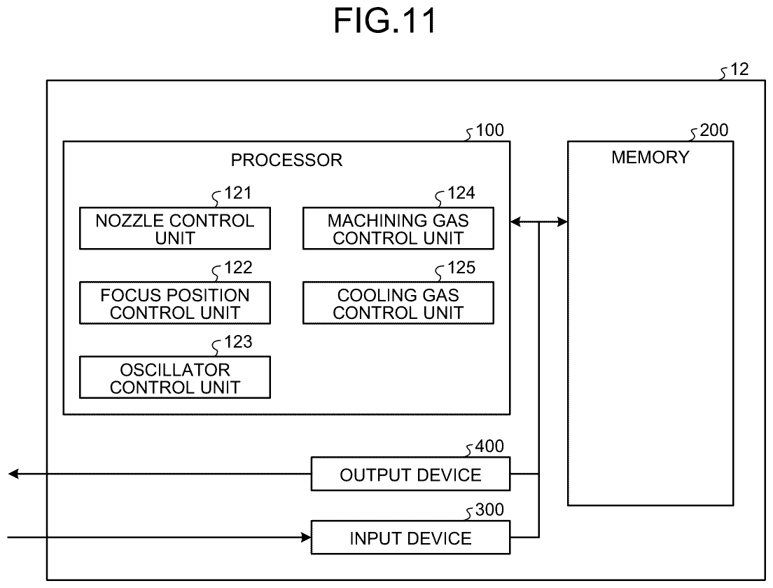

A hardware configuration of the controller 12 will now be described. FIG. 11 is a diagram illustrating an example of the hardware configuration for implementing the controller according to the embodiment. The controller 12 can be implemented by a processor 100, a memory 200, an input device 300, and an output device 400. An example of the processor 100 includes a Central Processing Unit (CPU, which may also be referred to as a central processor, a processing unit, an arithmetic unit, a microprocessor, a microcomputer, or a Digital Signal Processor (DSP)) or a system Large Scale Integration (LSI). Examples of the memory 200 include a Random Access Memory (RAM) and a Read Only Memory (ROM).

The controller 12 is implemented by the processor 100 reading and executing a computer-executable control program for executing operation of the controller 12 stored in the memory 200. It can also be said that the control program that is the program for executing the operation of the controller 12 is a program for causing a computer to execute a procedure or a method for the controller 12.

The control program executed by the controller 12 has a module configuration including the nozzle control unit 121, the focus position control unit 122, the oscillator control unit 123, the machining gas control unit 124, and the cooling gas control unit 125, which are loaded on a main storage device and generated on the main storage device.

The input device 300 receives the nozzle height sent from the nozzle position detector 14 and an instruction (such as the focus position 70) input by the user and sends the nozzle height and the instruction to the processor 100. The memory 200 stores, for example, the distance from the lowermost end of the nozzle 50A to the smallest-inner-diameter portion of the nozzle 50A. The memory 200 is used as a temporary memory when the processor 100 executes various processes. The output device 400 outputs various control instructions to the laser oscillator 11, the driver 13, the machining gas supply source 21, and the cooling gas supply source 31.

The control program may be stored in a computer-readable storage medium in an installable format file or an executable format file and may be provided as a computer program product. Furthermore, the control program may be provided to the controller 12 via a network such as the Internet. Note that, some of the functions of the controller 12 may be implemented by dedicated hardware such as a dedicated circuit, and some may be implemented by software or firmware.

As described above, since the focus position 70 of the laser light L1 is controlled such that the focus position 70 is located above the smallest-inner-diameter portion of the nozzle 50A, the laser machining apparatus 1 according to the embodiment can irradiate the target workpiece W1 with the laser light L1 having the increased beam width. The laser machining apparatus 1 irradiates the target workpiece W1 with the laser light L1 having the increased beam width, so that the energy density of the laser light L1 impinging on the target workpiece W1 can be kept low, and the machining can be stabilized as well. As a result, the laser machining apparatus 1 can stably cut, with high quality, a thick steel plate such as a mild steel plate having a plate thickness exceeding 25 mm, although such a thick plate is conventionally been difficult to machine.

Additionally, since the laser machining apparatus 1 includes the nozzle 50A having the divergent-shaped section, interference between the beam L1a of the laser light L1 and the nozzle 50A can be avoided. Furthermore, in the present embodiment, since the ring beam is not used, a special optical system for forming the ring beam is unnecessary, and the laser machining apparatus 1 can be manufactured at a low manufacturing cost.

Additionally, since the laser machining apparatus 1 cools the target workpiece W1 with the cooling gas 32, it is possible to prevent the beam L1b, which is the peripheral region of the laser light L1, from increasing the temperature of the nozzle 50A. Thus, the laser machining apparatus 1 can prevent the machining from becoming unstable due to the increase in temperature of the nozzle 50A, and hence continue stable machining.

The configurations described in the above embodiment are merely examples. The configurations may be combined with other well-known techniques, and some of the configurations may be omitted or changed without departing from the scope of the invention.

### REFERENCE SIGNS LIST

1 laser machining apparatus; 5 condensing lens; 10A, 10B, 10C machining head; 11 laser oscillator; 12 controller; 13 driver; 14 nozzle position detector; 15 optical path; 21 machining gas supply source; 22 machining gas; 23 machining gas path; 24, 34 gas pipe; 31 cooling gas supply source; 32 cooling gas; 33, 73 cooling gas path; 41 insulation part; 42 gas path; 50A, 50B, 50C nozzle; 61 spark; 70 focus position; 71 topmost portion; 72 bottommost portion; 100 processor; 121 nozzle control unit; 122 focus position control unit; 123 oscillator control unit; 124 machining gas control unit; 125 cooling gas control unit; 200 memory; 300 input device; 400 output device; L1 laser light; L1a, L1b beam; and W1 target workpiece.

1. A laser machining apparatus comprising:
a laser oscillator to output laser light having a wavelength band of 1 μm;
a machining head including: a nozzle having a divergent-shape on an outlet side thereof through which the laser light is emitted to a workpiece; and a condensing lens to condense the laser light at a focus position, the machining head being to eject machining gas to the workpiece, and eject cooling gas to the nozzle through a path different from a path for the machining gas, the machining gas being sent from a machining gas supply source to supply the machining gas, the cooling gas being sent from a cooling gas supply source to supply the cooling gas; and
a controller to control the focus position of the laser light, wherein
the nozzle is made of a cylindrical member and has an inner diameter decreasing toward a lower side thereof, the nozzle including a divergent-shaped section having an inner diameter increasing toward a lower side thereof,
the divergent-shape has a top portion defining a smallest-inner-diameter portion of the nozzle,
the controller controls the focus position of the laser light such that the focus position is located inside the machining head and away from the smallest-inner-diameter portion of the nozzle in a direction toward the condensing lens,
the laser light is emitted to the workpiece without a ring beam being formed, and
the machining gas is ejected to the workpiece coaxially with the laser light.

2. The laser machining apparatus according to claim 1, wherein
the nozzle includes a distal end portion on the outlet side through which the laser light is emitted, the distal end portion having an inner diameter of 2.0 mm or less, and
the controller controls the focus position such that the focus position is located at a height of +15 mm or more from an upper surface of the workpiece.

3. The laser machining apparatus according to claim 1, wherein
the nozzle has a flow path structure that allows the cooling gas to pass through an inside of the nozzle.

4. The laser machining apparatus according to claim 1, wherein
the controller performs control the laser light such that the laser light at the focus position has a diameter of 300 μm or less.

5. A laser machining method comprising:
controlling a focus position of laser light having a wavelength band of 1 μm;
ejecting machining gas to a workpiece and ejecting cooling gas to a nozzle through a path different from a path for the machining gas, the nozzle having a divergent-shape on an outlet side thereof through which the laser light is emitted to the workpiece, the machining gas being sent from a machining gas supply source to supply the machining gas, the cooling gas being sent from a cooling gas supply source to supply the cooling gas; and
outputting the laser light, wherein
the nozzle is made of a cylindrical member and has an inner diameter decreasing toward a lower side thereof, the nozzle including a divergent-shaped section having an inner diameter increasing toward a lower side thereof, the divergent-shape has a top portion defining a smallest-inner-diameter portion of the nozzle,
controlling the focus position of the laser light includes controlling the focus position such that the focus position is located inside a machining head including the nozzle and away from than the smallest-inner-diameter portion of the nozzle in a direction toward a condensing lens to condense the laser light at a focus position,
the laser light is emitted to the workpiece without a ring beam being formed, and
the machining gas is ejected to the workpiece coaxially with the laser light.

6. The laser machining apparatus according to claim 2, wherein
the nozzle has a flow path structure that allows the cooling gas to pass through an inside of the nozzle.

7. The laser machining apparatus according to claim 2, wherein
the controller performs control the laser light such that the laser light at the focus position has a diameter of 300 μm or less.

8. The laser machining apparatus according to claim 3, wherein
the controller performs control the laser light such that the laser light at the focus position has a diameter of 300 μm or less.

9. The laser machining apparatus according to claim 6, wherein
the controller performs control the laser light such that the laser light at the focus position has a diameter of 300 μm or less.
